(19) United States
(12) Patent Application Publication
(10) Pub. No.: US 2016/0317371 A1
(43) Pub. Date: Nov. 3, 2016

(54) Apparatus and Method for Supporting a Patient's Arm During a Medical Procedure

(71) Applicant: The Board of Regents, The University of Texas System, Austin, TX (US)

(72) Inventor: Nicole Wooden, Galveston, TX (US)

(21) Appl. No.: 15/144,017

(22) Filed: May 2, 2016

Related U.S. Application Data
(60) Provisional application No. 62/156,246, filed on May 2, 2015.

(51) Int. Cl. A61G 7/075

(52) U.S. Cl. CPC A61G 7/075

(57) ABSTRACT

In one embodiment, an apparatus for supporting a patient's arm includes a base member adapted to be slid underneath a mattress, an adjustable armature extending upward from the base member, and an arm support mounted to the armature adapted to directly support the patient's arm.

### CROSS-REFERENCE TO RELATED APPLICATION

This application claims priority to co-pending U.S. Provisional Application Ser. No. 62/156,246, filed May 2, 2015, which is hereby incorporated by reference herein in its entirety.

### BACKGROUND

There are various medical procedures in which a patient's arm must be supported relative to his or her body. For example, during cardiac catheterization via the arm, the arm must be supported and held steady to enable medical staff, such as a doctor or nurse, to insert a cardiac catheter into a blood vessel of the arm and pass it into the heart.

During such procedures, the patient's arm is typically supported by a flat board that is slid underneath a mattress upon which the patient rests. While such a board provides support to the patient's arm, it maintains the arm at a relatively low position, which may be difficult for the medical staff to access, particularly when the staff member is on the opposite side of the patient. In addition, because the arm is not held close to the patient's torso, it is possible for radiation used during the procedure (e.g., during a coronary angiography) to pass between the patient's arm and torso and be absorbed by the medical staff. This can be hazardous to the medical staff, particularly when they perform such procedures on a frequent basis.

From the above discussion, it can be appreciated that it would be desirable to have an alternative apparatus for supporting a patient's arm that does not suffer from the drawbacks of existing supports.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a side perspective view of an embodiment of an apparatus for supporting a patient's arm during a medical procedure.

FIG. 2 is a side view of the apparatus shown in FIG. 1.

FIG. 3 is a top view of the apparatus shown in FIG. 1.

### DETAILED DESCRIPTION

As described above, it would be desirable to have an apparatus for supporting a patient's arm during a medical procedure that overcomes the drawbacks of existing arm supports. Disclosed herein are examples of such apparatuses. In some embodiments, an apparatus includes a thin, planar base member that is adapted to slide underneath a mattress, an adjustable armature that extends upward from the base member, and an arm support that is mounted to the armature and adapted to directly support and secure the patient's arm in a desired position relative to the patient's torso.

In the following disclosure, various specific embodiments are described. It is to be understood that those embodiments are example implementations of the disclosed inventions and that alternative embodiments are possible. All such embodiments are intended to fall within the scope of this disclosure.

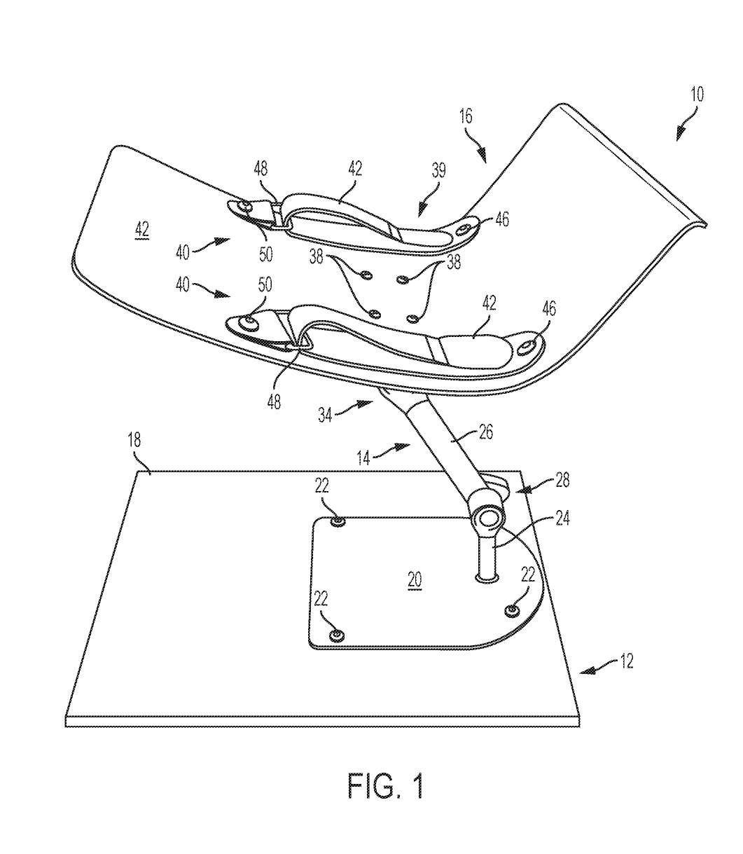

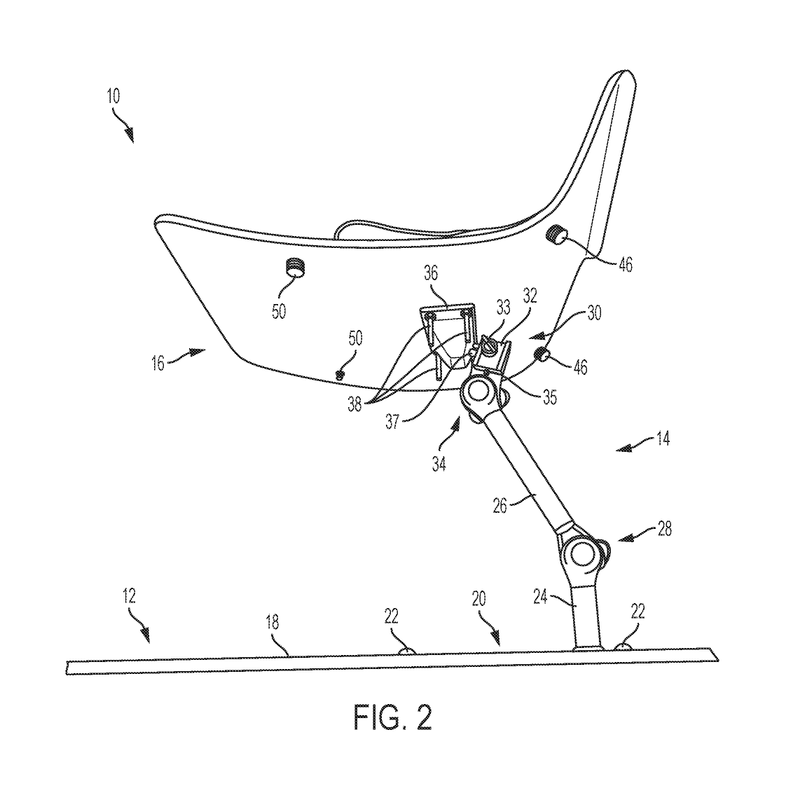

FIGS. 1-3 illustrate an example embodiment of an apparatus 10 for supporting a patient's arm during a medical procedure, such as cardiac catheterization. As shown in FIGS. 1 and 2, the apparatus 10 generally includes a base member 12, an adjustable armature 14, and an arm support 16. The base member 12 is a thin, planar member that is adapted to slide beneath a mattress upon which the patient rests. The base member 12 is dimensioned to ensure that it will be held securely in place by the patient's weight. In some embodiments, the base member 12 is generally rectangular and has an insertion depth (perpendicular to the length of the bed and the patient's body) of approximately 8 to 12 inches. The thickness of the base member 12 may depend upon the material from which it is made. When it is made of a polymeric material, the base member 12 can be approximately ¼ to 1 inch thick. When the base member 12 is made of a stronger material, such as metal, it can be thinner.

The adjustable armature 14 is securely mounted to the base member 12, for example to its top surface 18, and extends upwardly therefrom. As shown most clearly in FIG. 1, the armature 14 includes a mounting plate 20 that is adapted to facilitate such mounting. In the illustrated embodiment, the mounting plate 20 is a thin, planar member that is secured to the base member 12 with multiple threaded fasteners 22, such as screws. When the mounting plate 20 is thin and planar, it can also be slid underneath the mattress along with the base member 12. The mounting plate 20 can be made from an appropriate sturdy material, such as a polymeric or a metal material.

As shown most clearly in FIG. 2, the adjustable armature 14 includes multiple arm segments. In the illustrated example, the armature 14 includes a first (lower) arm segment 24 and a second (upper) arm segment 26 that is connected to the first arm segment. Both arm segments 24, 26 are configured as elongated members, such as rods. In some embodiments, each arm segment 24, 26 is approximately 2 to 8 inches long. Like the mounting plate 20, the arm segments 24, 26 can be made from an appropriate sturdy material, such as a polymeric or a metal material.

With further reference to FIG. 2, the first arm segment 24 is fixedly connected to the mounting plate 20 at the arm's proximal end. The first and second arm segments 24, 26 are pivotally connected to each other with a first (lower) lockable hinge joint 28. In particular, the proximal end of the second arm segment 26 is connected to the distal end of the first arm segment 24 with the hinge joint 28. Because of the presence of the hinge joint 28, the angle between the arm segments 24, 26 can be adjusted and then locked to place the arm support 16, and the patient's arm, in a desired orientation. Notably, adjustment of the hinge joint 28 changes not only the position of the arm support 16 in a direction perpendicular to the length of the bed and the patient's body but also the height of the arm support. Locking is facilitated by a locking mechanism that, for example, comprises a twistable nut or knob that prevents relative movement of the arm segments 24, 26 when tightened by the user. Angular adjustment of the second arm segment 26 can be achieved by loosening the locking mechanism, repositioning the second arm segment relative to the first arm segment 24, and retightening the locking mechanism.

As is also shown in FIG. 2, a lockable swivel mechanism 30 is mounted to the distal end of the second arm segment 26. This swivel mechanism 30 includes a swivel body 32 that is connected to the second arm segment 26 with a second (upper) lockable hinge joint 34. As shown in FIG. 2, this connection is facilitated by a first short shaft 35 that extends from the swivel body 32 to the hinge joint 34. The second hinge joint 34 enables the angle of the swivel body 32 to be adjusted relative to the second arm segment 26 and then locked in a desired position to further adjust the arm support 16.

The swivel mechanism 30 enables the arm support 16 to swivel about a central point within the swivel body 32. As shown in FIG. 2, a second short shaft 37 extends from the swivel body 32 to a mounting member 36 secured to its distal end. The mounting member 36 is also secured to the arm support 16 with threaded fasteners 38, such as bolts. In some embodiments, the fasteners 38 can be made of a radiolucent material, such as a polymeric material, so that they will not appear in x-ray images. The proximal end of the second short shaft 37 includes a ball (not visible) that is received within a socket (not visible) within the swivel body 32 so as to form a ball-and-socket joint that enables swiveling of the mounting member 36 and, therefore, the arm support 16.

Because of the swivel mechanism 30, the position of the arm support 16 can be adjusted not only within the plane of the arm segments 24, 26 but also forward, rearward, and laterally. Like the hinge joints 28, 34, the swivel mechanism 30 can be locked once a desired orientation has been achieved. The swivel mechanism 30 can incorporate a locking mechanism that is tightened with a twistable nut or knob 33. Through manipulation of the first hinge joint 28, the second hinge joint 34, and the swivel mechanism 30, the patient's arm can be supported and locked in nearly any desired orientation. In some embodiments, the patient's arm can be supported and locked in a position in which the arm is close to and/or overlaps the patient's torso. Such a position may reduce the amount of radiation to which medical staff are exposed.

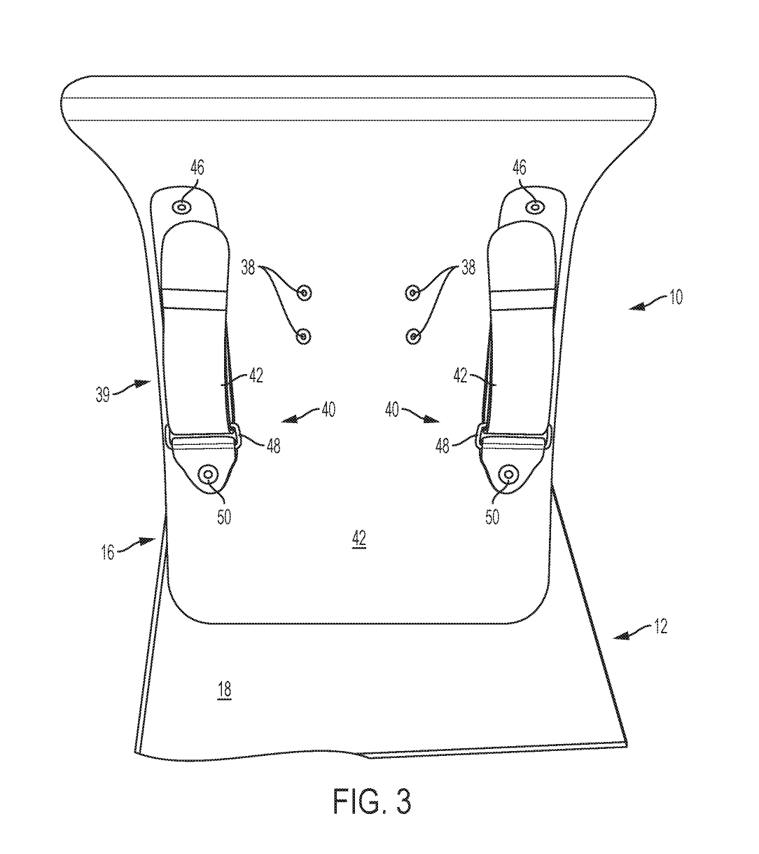

Referring next to FIGS. 1 and 3, the arm support 16 comprises a thin, curved (e.g., concave) element that forms a trough 39 in which the patient's arm can rest during a medical procedure. The arm support 16 can be made of a radiolucent material, such as a polymeric material. In some embodiments, the arm support 16 also comprises adjustable arm straps 40 that are mounted to the top surface 42 of the arm support. When provided, these straps 40 can be used to secure the patient's arm to keep it still during the medical procedure. In the illustrated embodiment, the straps 40 each include a fabric strap element 42 that is attached to the arm support 16 with a threaded fastener 46 and a buckle 48 that is likewise attached to the arm support with a threaded fastener 50. The strap elements 42 thread through their associated buckles 48 and attach to themselves with fastening elements, such as strips of hook-and-loop material. Like the fasteners 38, the fasteners 46, 50 can be made of a radiolucent material.

Various modifications can be made to the above-described apparatus, if desired. For example, one or more further adjustment mechanisms can be provided to the armature to enable adjustment of the height of the arm support without requiring significant repositioning in other directions. In some embodiments, the further adjustment mechanisms can include a telescopic adjustment mechanism with which the length of the armature can be adjusted. As another example modification, foam or neoprene padding can be provided on the top surface of the arm support to increase patient comfort.

Claimed are:

1. Apparatus for supporting a patient's arm, the apparatus comprising:
a base member adapted to be slid underneath a mattress;
an adjustable armature extending upward from the base member; and
an arm support mounted to the armature adapted to directly support the patient's arm.

2. The apparatus of claim 1, wherein the base member is generally planar.

3. The apparatus of claim 1, wherein the base member is generally rectangular.

4. The apparatus of claim 1, wherein the adjustable armature comprises multiple arm segments connected by adjustable joints.

5. The apparatus of claim 1, wherein the adjustable armature comprises a mounting plate that mounts the armature to the base member.

6. The apparatus of claim 5, wherein the adjustable armature comprises a first arm segment that extends upward from the mounting plate.

7. The apparatus of claim 6, wherein the adjustable armature further comprises a second arm segment that is mounted to a distal end of the first arm segment with a first lockable hinge joint.

8. The apparatus of claim 7, wherein the adjustable armature further comprises a lockable swivel mechanism that is mounted to a distal end of the second arm segment with a second lockable hinge joint.

9. The apparatus of claim 8, wherein the arm support is mounted to the swivel mechanism.

10. The apparatus of claim 9, wherein the swivel mechanism comprises a swivel body and a short shaft that extends from the body, the shaft having a ball at its proximal end that is received by a socket within the body.

11. The apparatus of claim 10, further comprising a mounting member that is secured to a distal end of the short shaft and to the arm support.

12. The apparatus of claim 1, wherein the arm support is thin and curved.

13. The apparatus of claim 1, further comprising adjustable arm straps attached to a top surface of the arm support.

14. The apparatus of claim 13, wherein the arm straps include hook-and-loop fastening elements.

15. Apparatus for supporting a patient's arm for a medical procedure, the apparatus comprising:
a generally planar base member adapted to be slid underneath a mattress;
an adjustable armature extending upward from the base member, the armature comprising a first arm segment mounted to the base member, a second arm segment connected to a distal end of the first arm segment with a first lockable hinge joint, and a lockable pivot mechanism connected to a distal end of the second arm segment with a second lockable hinge joint; and
a curved arm support adapted to directly support the patient's arm, the arm support being connected to the pivot mechanism of the armature;
wherein the arm support, and therefore the patient's arm, can be moved to a desired position while the hinge joints and the pivot mechanism are unlocked and secured in the desired position by locking the hinge joints and pivot mechanism.

16. A method of supporting a patient's arm, the method comprising:
sliding a base member of a supporting apparatus under a mattress upon which the patient rests;
adjusting an adjustable armature that extends upward from the base member such that an arm support mounted to the armature and adapted to directly support the patient's arm is positioned in a desired orientation relative to the patient's torso above the mattress;
locking the armature in the desired orientation; and
placing the patient's arm in the arm support such that the arm is positioned in a desired orientation relative to the patient's torso.

17. The method of claim 16, further comprising securing the patient's arm to the arm support with adjustable arm straps.

18. The method of claim 16, further comprising unlocking the adjustable armature, repositioning the arm support into a new orientation, and relocking the adjustable armature with the arm support in the new orientation.
